(19) United States
(12) Patent Application Publication
(10) Pub. No.: US 2017/0071227 A1
(43) Pub. Date: Mar. 16, 2017

(54) BAGLESS AND REUSABLE PRODUCT DISPOSING BIN

(71) Applicant: Vita-Mix Management Corporation, Olmsted Township, OH (US)

(72) Inventors: David J. Kolar, Stow, OH (US); Fred H. Mehlman, Brunswick, OH (US)

(21) Appl. No.: 15/307,117

(22) PCT Filed: Jun. 2, 2015
(86) PCT No.: PCT/US2015/033679

§ 371 Date: Oct. 27, 2016

Related U.S. Application Data
(60) Provisional application No. 62/006,350, filed on Jun. 2, 2014.

(51) Int. Cl. A23G 9/22; B65D 25/14; B65D 25/38; B65D 51/24

(52) U.S. Cl. CPC A23G 9/22; B65D 51/245; B65D 25/14; B65D 25/38

(57) ABSTRACT

A modular blending system including a bin is provided; the bin being for consumable products has a well in the bottom thereof. A bottom surface of the bin is sloped from substantially a plurality of sides toward the well to facilitate evacuation of the consumable product into and through the well. An outlet fixture connected through an opening in the well may be connected to a dispenser, thereby allowing evacuation of the consumable product from the well to the dispenser. The bin may also have side walls for supporting the bin, and/or a lid for covering at least a portion of the top of the bin.

### CROSS REFERENCE TO RELATED APPLICATION

This application claims priority to U.S. Provisional Application Ser. No. 62/006,350, filed on Jun. 2, 2014, entitled “BAGLESS BIN/REUSABLE PRODUCT DISPOSING BIN”, the entirety of which is incorporated herein by reference.

### BACKGROUND

The present disclosure relates to a bagless bin or reusable product disposing bin. More specifically, the present disclosure relates to a standardized, reusable, and bagless bin for dispensing products.

Restaurants, shops, and other retailers prepare and serve juice drinks, smoothies, or other food or beverage-related products for their patrons. Many times the consumable product being served (e.g., juice, smoothie mix, flavoring, liquid yogurt or the like) is dispensed from some type of dispenser for the purposes of accuracy and automation into a container for processing such as to blend. Consumable product manufacturers use many different packaging configurations in the form of bags and cartons depending on manufacturing design preferences, the type of food or liquid, quantity, and storage and transport requirements. Thus, it may be difficult for one dispensing machine to accommodate the many different shapes and sizes of packaging materials from different manufacturers. With so many differing packaging configurations, it is also difficult to standardize to one type that will fit the dispensing machine. Additionally, there is often incomplete evacuation of the product from the cartons and bags, which may result in waste of the product. For example, 3-10% of the consumable may be left behind in the packaging, and often the amount left is inconsistent. This unused amount of consumable creates waste and can also lead to increased costs and/or lost profits.

### BRIEF SUMMARY

According to one example described herein, a consumable product bin comprises a plurality of side surfaces; a bottom surface; and a well disposed within the bottom surface, the well comprising a plurality of side surfaces and a bottom surface, wherein the bottom surface of the bin slopes generally downward toward the well from at least one of the plurality of side surfaces and the well includes at least one opening to which an outlet fixture is connected, the outlet fixture allowing the consumable product in the bin to flow through the well and into another receptacle.

In various embodiments of the above example, the outlet fixture is positioned at a downward angle to facilitate the flow of the consumable product; the bin further comprises at least two walls, each peripherally located outside of one of the plurality of side surfaces of the bin; the weight of the bin is supported by the at least two walls and, in supporting the weight of the bin, the at least two walls position the bin in an operative position; the bin and well are coated with a non-stick material; the bin further comprises a lid; the lid comprises an indicator of the level of product held within the bin; the outlet fixture is connected to a dispenser via tubing so as to allow the flow of the consumable product from the bin to the dispenser; and/or the consumable product is a liquid or flowable substance.

According to another example, a bin for a consumable product comprises a housing with an open top for holding the consumable product; a well at a bottom of the housing; an opening in the well; and an outlet fixture connected through the opening in the well, wherein, the bottom of the housing is sloped toward the well so as to cause the consumable product to evacuate the bin through the outlet fixture in the opening of the well.

In various embodiments of the above example, the outlet fixture is positioned at a downward angle to facilitate the flow of the consumable product; the bin further comprises at least two walls, each peripherally located outside of the housing of the bin; the weight of the bin is supported by the at least two walls and, in supporting the weight of the bin, the at least two walls position the bin in an operative position; the housing and well are coated with a non-stick material; the bin further comprises a lid; the lid comprises an indicator of the level of product held within the bin; the outlet fixture is connected to a dispenser via tubing so as to allow the flow of the consumable product of the bin to the dispenser; and/or the consumable product is a liquid or flowable substance.

According to yet another example, a modular blending system comprises a blending apparatus for blending a consumable product; and a storage unit, the storage unit having at least one bin for the consumable product that comprises a housing with an open top for holding the consumable product; and a well at a bottom of the housing, the well being operatively connected to the blender, wherein, the bottom of the housing is sloped toward the well so as to cause the consumable product to evacuate from the bin to the blending apparatus through the well.

In various embodiments of the above example, the outlet fixture is positioned at a downward angle to facilitate the flow of the consumable product; the bin further comprises at least two walls, each peripherally located outside of the housing of the bin; the weight of the bin is supported by the at least two walls and, in supporting the weight of the bin, the at least two walls position the bin in an operative position; the housing and well are coated with a non-stick material; the bin further comprises a lid; the lid comprises an indicator of the level of product held within the bin; the outlet fixture is connected to a dispenser via tubing so as to allow the flow of the consumable product of the bin to the dispenser; and/or the consumable product is a liquid or flowable substance.

### BRIEF DESCRIPTION OF THE DRAWINGS

FIG. 1 illustrates a perspective view of one embodiment of a bagless bin described herein;

FIG. 2 illustrates a perspective view of one embodiment of the bagless bin;

FIG. 3 illustrates a perspective view of one embodiment of the bagless bin without a lid;

FIG. 4 illustrates a cross-section of one embodiment of the bagless bin;

FIG. 5 illustrates a perspective view of one embodiment of the bagless bin disposed within and connected to a dispenser;

FIG. 6 illustrates a perspective view of one embodiment of the bagless bin disposed within and connected to a dispenser;

FIG. 7 illustrates a cross-section of one embodiment of the bagless bin disposed within and connected to a dispenser; and

FIG. 8 illustrates a perspective view of a modular blending system having a storage unit with a bagless bin described herein.

### DETAILED DESCRIPTION

Certain terminology is used herein for convenience only and is not to be taken as a limitation on the present teachings. Relative language used herein is best understood with reference to the drawings, in which like numerals are used to identify like or similar items. Further, in the drawings, certain features may be shown in somewhat schematic form.

A bagless bin or reusable product disposing bin is provided which facilitates dispensing a variety of consumables from a variety of manufacturers, and that consistently evacuates all or substantially all of the product from the bin. More specifically, the subject bin relates to a standardized, reusable, and bagless bin for dispensing products to consumers. For example, such products may include, without limitation, juice, smoothie mix, flavoring, syrups, liquid yogurt or the like, that are typically added to food and drink product. Consumables are often dispensed by a dispenser for the purposes of accuracy and automation in restaurants, shops, and other retailers. Liquid consumables are generally contained within a packaging designed by the consumable's manufacturer or distributor. The packaging is disposed within and connected to the dispensers such that the liquid consumable within the bag can be dispensed through an external dispensing outlet on the dispenser. Below is described a reusable bagless bin in which the liquid consumable may be poured or emptied from its packaging. The bin is standardized to fit within a dispenser and designed to successfully evacuate all or substantially all of the consumable. Accordingly, any product, regardless of its packaging may be substantially or more completely dispensed, resulting in less to no measurable amount of waste. The subject bin may be reused, for example, by cleaning and refilling with a consumable product.

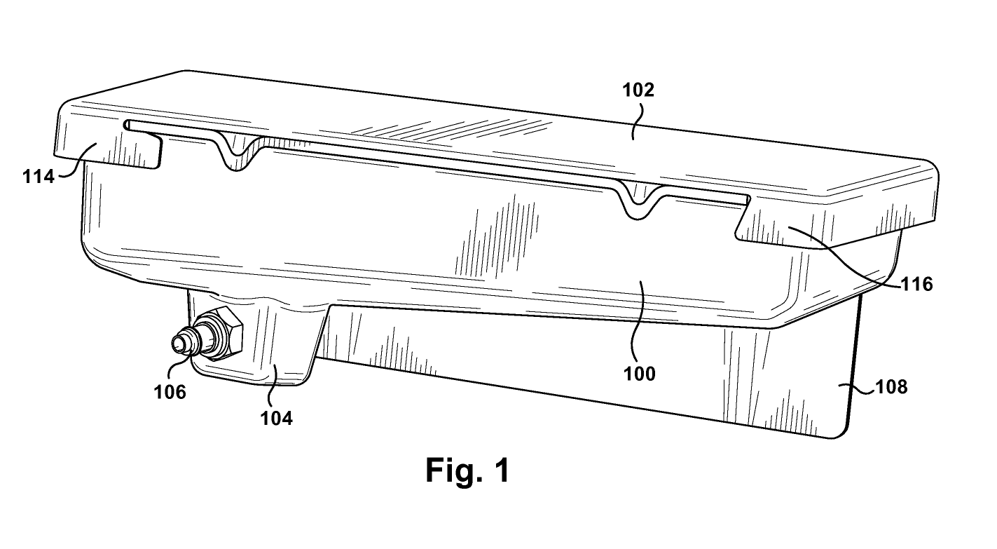

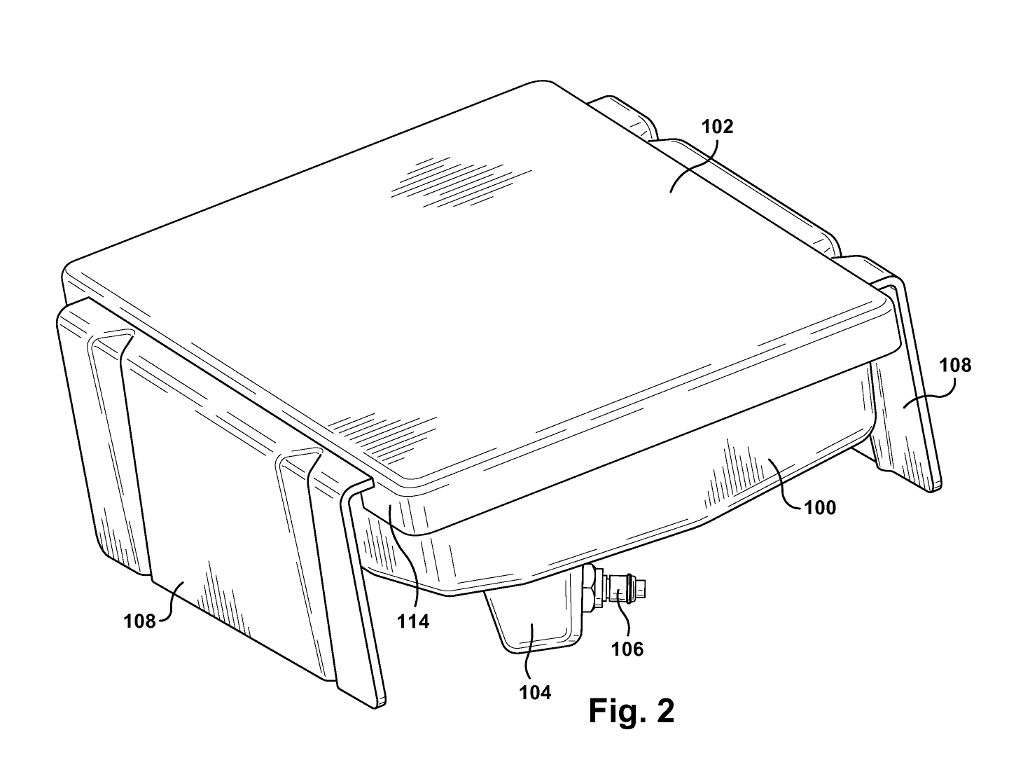

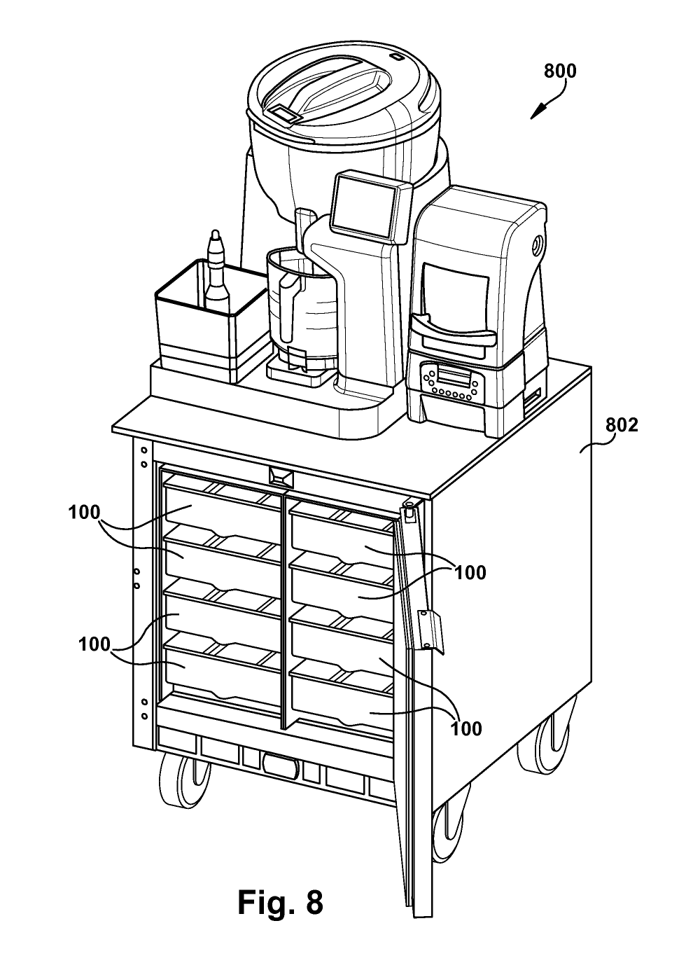

Referring now to the figures, FIGS. 1 and 2 illustrate perspective views of a bagless bin 100 with a lid cover 102. The bin 100 may be configured to operatively fit within a storage device, such as that disclosed in U.S. patent application Ser. No. 14/061,103, which is hereby incorporated by reference. The bin 100 may be made from any material suitable for flowable consumable products. For example, the bin 100 may be made from a plastic or metal depending on desired costs and physical requirements, such as weight. By way of a non-limiting example, the material may include any food safe material such as aluminum, Tritan, high density polyethylene, low density polyethylene, polypropylene or the like. Further, the bin 100 may be coated with a nonstick material to aid in cleaning and evacuation or flow of the consumable product. For example, such nonstick material may include any product containing low surface adhesion properties while also being food safe. As can be seen in FIG. 1, the bottom of the bin 100 may be generally sloped toward a small well 104. In some embodiments, the slope of the bin 100 is from all or substantially all sides (in all or substantially all directions) of the bin 100 to the well 104. In other embodiments, the slope of the bin 100 may be from a minority of the sides of the bin 100 to the well 104. This sloped design of the bin 100 allows product to drain into the well 104, where it is eventually evacuated into another receptacle (not shown), thereby decreasing the amount of product that remains in the packaging or wasted. By way of a non-limiting example, the bin 100 may be inserted into a storage unit 802, such as shown in FIG. 8. The storage unit 802 may be part of a modular blending system 800, such as that described in U.S. patent application Ser. No. 14/061,103, which is herein incorporated by reference in its entirety.

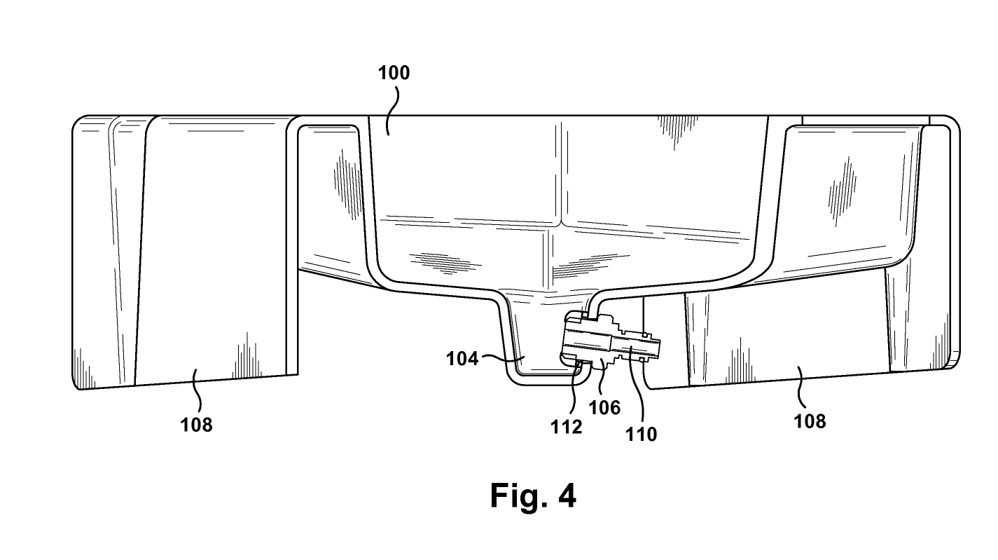

An outlet fixture 106 comprising a conduit 110 (see FIG. 4) is connected to the well 104, through which the product is evacuated into another receptacle for further processing or serving (not shown). Like the bin 100, the fixture 106 may be made from any suitable material for holding the consumable product. Such materials may include plastics and metals or any food safe material such as aluminum, Tritan, high density polyethylene, low density polyethylene, polypropylene or the like. Further, the conduit 110 may be coated with a nonstick material similar to that of the bin 100. While FIGS. 1 and 2 illustrate the fixture 106 positioned or connected to a side of the well 104, it should be noted that the fixture 106 may be located anywhere on the well 104, including the bottom surface of the well 104. The location of the fixture 106 may be determined, for example, based on physical constraints of the bin 100 or dispenser, the physical requirements of the fixture itself, the evacuation requirements of the desired liquid consumable products to be used, the configuration of the storage unit 802, the system to which it is used 800, and the like. The outlet fixture 106 may also be angled downwardly so as to facilitate flow of the consumable product out of the well by gravity. However, a pump (not shown) may also be used to cause the consumable product to flow through the outlet fixture 106.

Walls 108, externally attached to the bin 100 and its sides, are also illustrated and may be used for mounting the bin 100 into a dispenser, for example. The walls 108 may extend below the well 104 such that if the walls 108 are used for mounting they provide enough clearance for the well 104 and fixture 106. Further, the walls 108 may be utilized to position the bin 100 in an operative position within the storage unit 802. For example, the walls 108 may fit within a mating slot of the storage unit 802 to keep the bin 100 in its operative position. However, it is envisioned that some configurations of dispensers may not require that the walls 108 extend below the well 104 in order to provide sufficient clearance. While FIG. 2 illustrates two walls 108 on opposite sides of the bin 100, it should be noted that other configurations are contemplated and within the scope of this description to the extent that their configuration provides sufficient clearance for the well and fixture to operate as described herein. The second wall of FIG. 1 is not shown in order to illustrate the well 104 and fixture 106. Any placement, dimensions, and number of walls, depending on mounting requirements of the dispenser, is envisioned to be within the scope of the present disclosure.

As with the structure of the bin 100, the lid cover 102 may be made of any material such as plastic or metal, including, without limitation any kind of food safe material such as aluminum, Tritan, high density polyethylene, low density polyethylene, polypropylene or the like. As illustrated in FIGS. 1 and 2, the lid cover 102 is a solid structure that completely covers the top of the bin 100 and may be transparent or opaque as shown in FIG. 1. In those embodiments in which the lid cover 102 is transparent, the user may be able to view the contents within the bin 100 to determine an amount of the product within the bin 100. This may provide a visual indicator for the user to determine when to add more product to the bin 100 or replace the bin 100 with one that is full. The lid cover 102 may have a catch (or catches) 114, 116 that fit around the tops of walls 108, allowing the lid cover 102 to lock into place on the bin 100. In the illustrated embodiments, catch 116 has a beveled edge allowing it to slide along the edge of the wall 108. In this way, the side of the lid containing catch 116 may be lifted to release the catch 116, and then pushed backward to release catch 114, thereby removing the lid cover 102 from the bin 100. In other embodiments, the catches 114 and 116 may be used to snap the lid cover 102 on and off the bin 100. In still other embodiments, the lid cover 102 may be permanently hinged to the bin 100. In still other embodiments, the lid cover 102 may be slideably attached to and removed from the bin 100, for example, with rails integrally formed on the bin 100 and/or lid cover 102. Still other embodiments in which the lid cover 102 can provide and restrict access to the contents of the bin 100 are envisioned to be within the scope of the present disclosure. Further still, the lid cover 102 may include an indicator that identifies the amount of product within the bin 100 or may identify when the product reaches a predetermined level, e.g., identifies when there is little or no product within the bin 100. The indicator may be of any appropriate configuration or type, including, without limitation, a digital indicator, a float, etc.

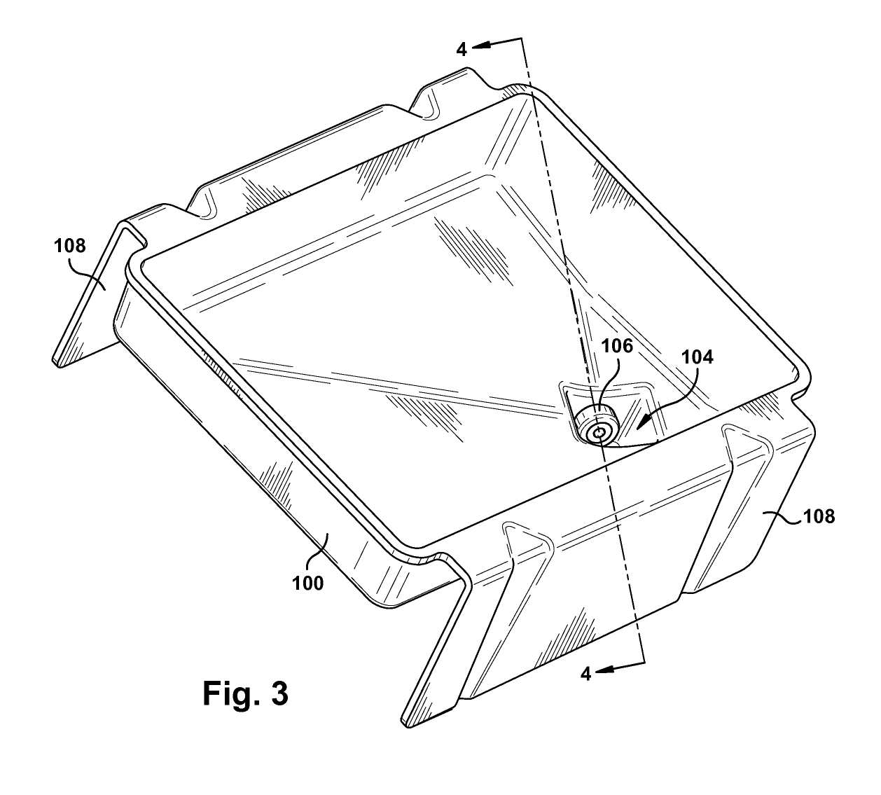

FIG. 3 illustrates another perspective view of the bin 100 shown without the lid cover 102. Looking inside the bin 100, the well 104 is located near one corner of the bin 100. However, it should be noted that the location of the well 104 could be anywhere within the bin 100, as long as the bottom of the bin 100 slopes toward the well 104. The location may be determined, for example, based on physical requirements of the bin 100 and/or dispenser, the evacuation requirements of the consumable product, or the like. The fixture 106 is shown inside the well and walls 108 are shown attached to opposite sides of the bin 100.

FIG. 4 illustrates a cross-section of the bin 100 as illustrated by the dotted line in FIG. 3. The fixture 106 is shown penetrating a cutout in the well 104. The conduit 110 is shown through the middle of the fixture 106. A seal 112 is provided around the fixture 106 in the well 104 to prevent leaking of the consumable through the cutout in the well 104. The seal 112 may be a plastic, rubber, waterproof foam, or the like so long as it substantially covers any gaps between the fixture 106 and cutout to prevent leaking of the consumable product. The portion of the fixture 106 exterior to the well 104 may also comprise ridges or locking mechanisms to enable the secure and leak proof attachment of a flexible tubing 506.

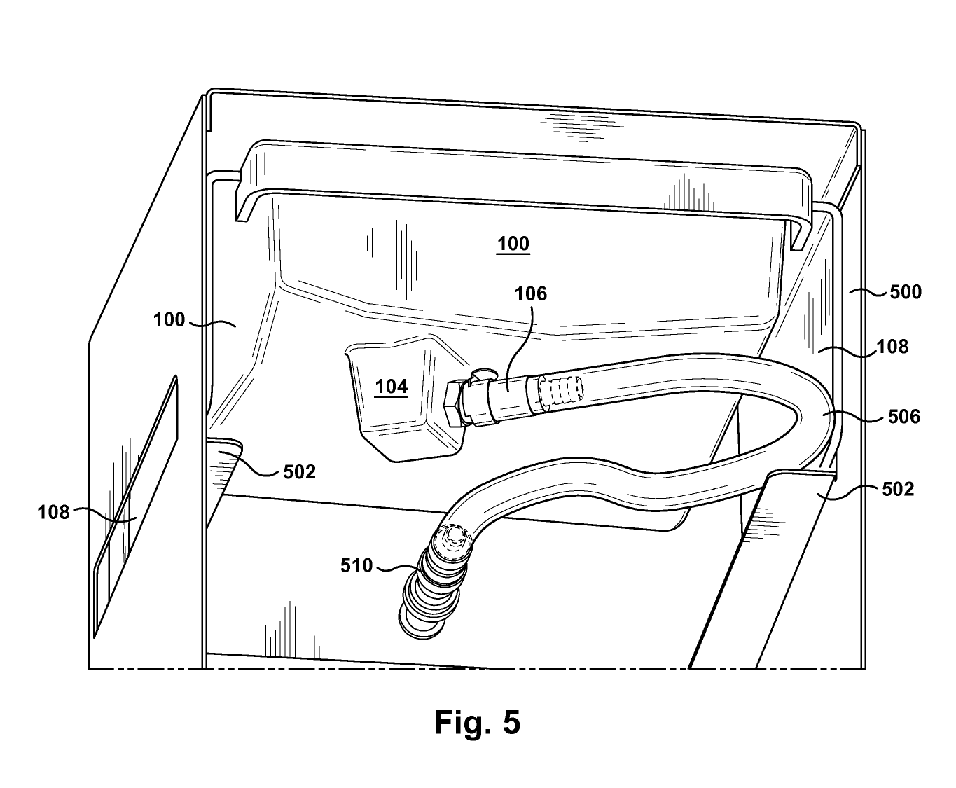

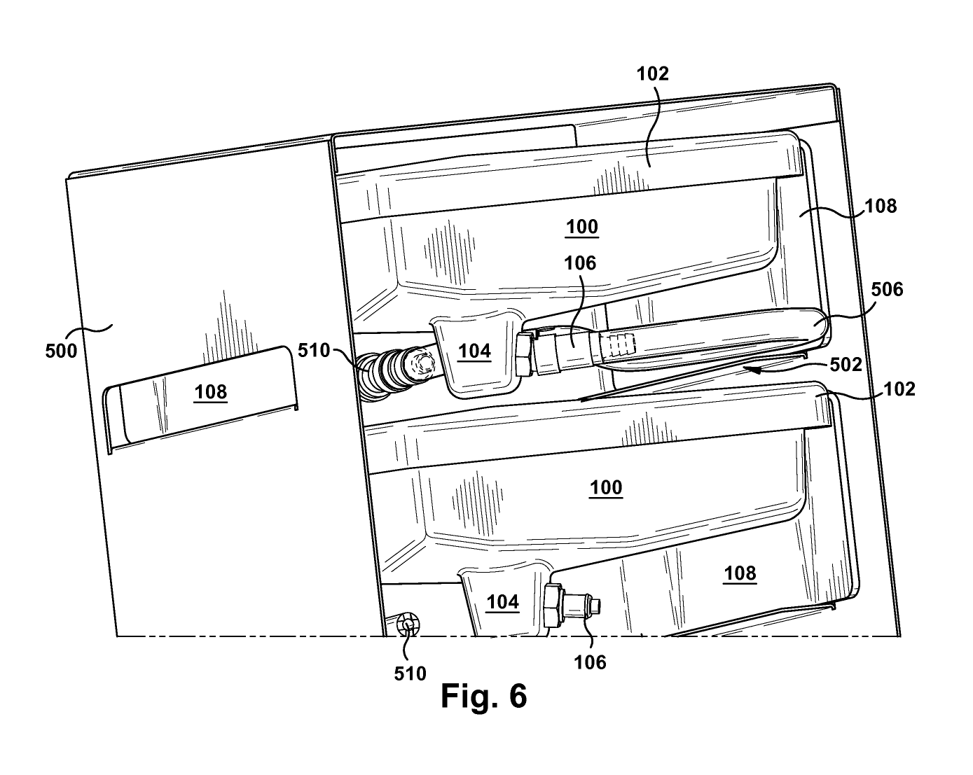

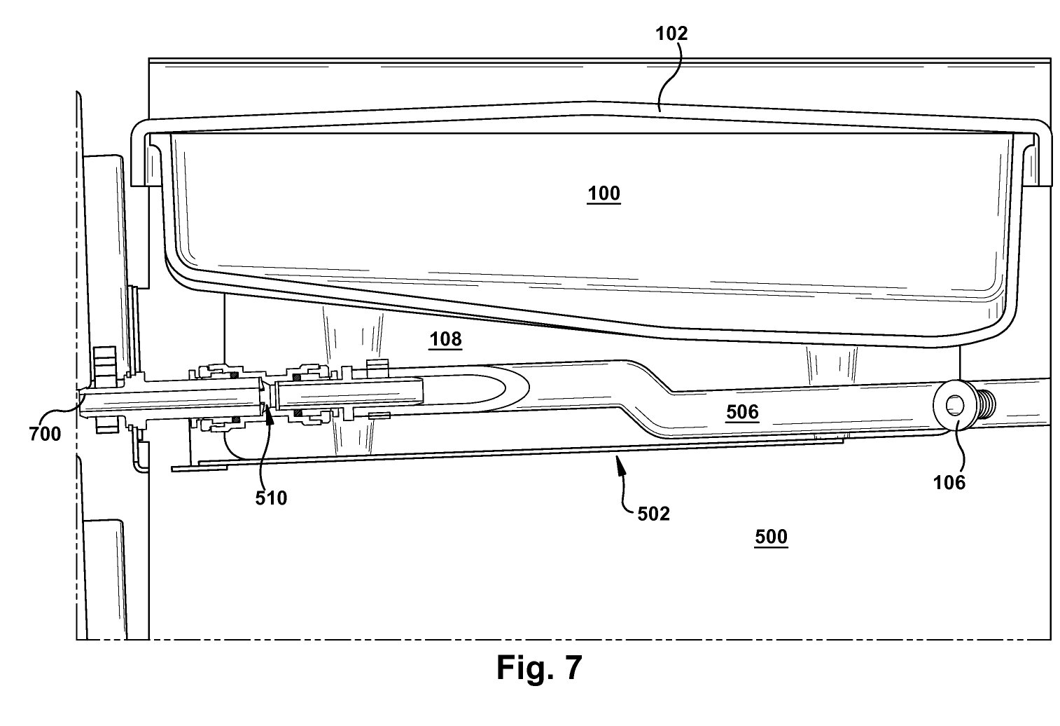

FIGS. 5 and 6 illustrate the bin 100 disposed within and connected to a dispenser 500. The walls 108 of the bin 100 rest on a ledge support 502 such as a shelf (or shelf elements) within the dispenser 500 to support the bin 100. In other embodiments, it is envisioned that the walls 108 could be mounted to the sides of the dispenser 500 rather than resting on a shelf or ledge support 502. FIGS. 6 and 7 show the lid cover 102 disposed on top of the bin 100. Flexible tubing 506 is connected to the fixture 106 on one end and a dispenser port 510 of the dispenser 500 on another end such that the flexible tubing 506 provides a pathway for the consumable product to travel from the bin 100 to the dispenser 500. As illustrated in FIG. 6, more than one bin 100 can be arranged within a dispenser 500. For example, a second bin 100 may be located within the dispenser 500 underneath the first bin 100. While the configuration illustrated in FIG. 6 is vertical, it should be noted that various bins may instead, or additionally, be placed next to each other, depending on the configuration of the dispenser 500.

FIG. 7 illustrates a cross section of the bin 100 disposed within and connected to a dispenser 500. Again, a lid 102, fixture 106, wall 108, shelf 502, flexible tubing 506, and dispenser port 510 are illustrated. Additionally, it is shown that the dispenser port 510 leads to an external outlet 700, through which the consumable product is ultimately dispensed to a consumer.

In operation, a user may fill or the bin 100 may come from the supplier pre-filled with the appropriate product. The bin 100 may be inserted into the storage unit 802 in any appropriate manner. The present teachings, however, are not limited to the storage unit 802 shown and described herein. Any kind of storage unit may be utilized. Once installed, the fixture 106 and flexible tubing 506 may be operatively attached or may come pre-attached such as from the supplier. An opposite end of the flexible tubing 506 may then be attached with the storage unit 802 or a dispenser in any appropriate manner. As identified above, the bin 100 may be utilized with a mobile blending system 800. In such embodiments, once the bin 100 is operatively inserted into the storage unit 802, the flexible tubing 506 (or any kind of evacuation system) may be operatively secured with the dispenser. Once inserted and operatively assembled, the user may operate the modular blending system 800. By way of a non-limiting example, the flavoring or syrup for a frozen drink may be evacuated from the bin 100 through a dispenser and into a blending container. The blending container may include ice. Once all ingredients are added, the user may operate the blending device and blend the contents within the blending container creating a frozen drink.

It should be evident that this disclosure is by way of example and that various changes may be made by adding, modifying or eliminating details without departing from the fair scope of the teaching contained herein. The present teachings are therefore not limited to particular details of this disclosure except to the extent that the following claims are necessarily so limited.

What is claimed is:

1. A consumable product bin comprising:
a plurality of side surfaces;
a bottom surface; and
a well disposed within the bottom surface, the well comprising a plurality of side surfaces and a bottom surface,
wherein the bottom surface of the bin slopes generally downward toward the well from at least one of the plurality of side surfaces of the bin and the well includes at least one opening to which an outlet fixture is connected, the outlet fixture allowing the consumable product in the bin to flow through the well and into another receptacle.

2. The bin of claim 1, wherein the outlet fixture is positioned at a downward angle to facilitate the flow of the consumable product.

3. The bin of claim 1 further comprising at least two walls, each peripherally located outside of one of the plurality of side surfaces of the bin.

4. The bin of claim 3, wherein the weight of the bin is supported by the at least two walls and, in supporting the weight of the bin, the at least two walls position the bin in an operative position.

5. The bin of claim 1, wherein the bin and well are coated with a non-stick material.

6. The bin of claim 1 further comprising a lid.

7. The bin of claim 6, wherein the lid comprises an indicator of the level of product held within the bin.

8. The bin of claim 1, wherein the outlet fixture is connected to a dispenser via tubing so as to allow the flow of the consumable product from the bin to the dispenser.

9. The bin of claim 1, wherein the consumable product is a liquid or flowable substance.

10. A bin for a consumable product comprising:
a housing with an open top for holding the consumable product;
a well at a bottom of the housing;
an opening in the well; and
an outlet fixture connected through the opening in the well,
wherein, the bottom of the housing is sloped toward the well so as to cause the consumable product to evacuate the bin through the outlet fixture in the opening of the well.

11. The bin of claim 10, wherein the outlet fixture is positioned at a downward angle to facilitate the flow of the consumable product.

12. The bin of claim 10 further comprising at least two walls, each peripherally located outside of the housing of the bin.

13. The bin of claim 12, wherein the weight of the bin is supported by the at least two walls and, in supporting the weight of the bin, the at least two walls position the bin in an operative position.

14. The bin of claim 10, wherein the housing and well are coated with a non-stick material.

15. The bin of claim 10 further comprising a lid.

16. The bin of claim 15, wherein the lid comprises an indicator of the level of product held within the bin.

17. The bin of claim 10, wherein the outlet fixture is connected to a dispenser via tubing so as to allow the flow of the consumable product of the bin to the dispenser.

18. The bin of claim 10, wherein the consumable product is a liquid or flowable substance.

19. A modular blending system comprising:
a blending apparatus for blending a consumable product; and
a storage unit, the storage unit having at least one bin for the consumable product that comprises:
a housing with an open top for holding the consumable product; and
a well at a bottom of the housing, the well being operatively connected to the blending apparatus,
wherein, the bottom of the housing is sloped toward the well so as to cause the consumable product to evacuate from the bin to the blending apparatus through the well.

20. The system of claim 19, wherein the outlet fixture is positioned at a downward angle to facilitate the flow of the consumable product.

21. The system of claim 19 further comprising at least two walls, each peripherally located outside of the housing of the bin.

22. The system of claim 21, wherein the weight of the bin is supported by the at least two walls and, in supporting the weight of the bin, the at least two walls position the bin in an operative position.

23. The system of claim 19, wherein the housing and well are coated with a non-stick material.

24. The system of claim 19 further comprising a lid.

25. The system of claim 24, wherein the lid comprises an indicator of the level of product held within the bin.

26. The system of claim 19, wherein the outlet fixture is connected to a dispenser via tubing so as to allow the flow of the consumable product of the bin to the dispenser.

27. The system of claim 19, wherein the consumable product is a liquid or flowable substance.
